(19) United States
(12) Patent Application Publication
(10) Pub. No.: US 2025/0254718 A1
(43) Pub. Date: Aug. 7, 2025

(54) METHOD AND APPARATUS FOR POSITIONING UE IN WIRELESS COMMUNICATION SYSTEM

(71) Applicant: Samsung Electronics Co., Ltd., Gyeonggi-do (KR)

(72) Inventors: Mythri HUNUKUMBURE, Middlesex (GB); Oluwatayo KOLAWOLE, Middlesex (GB)

(21) Appl. No.: 19/184,514

(22) Filed: Apr. 21, 2025

Related U.S. Application Data
(63) Continuation of application No. 17/525,087, filed on Nov. 12, 2021.

(30) Foreign Application Priority Data
Nov. 16, 2020 (GB) 2017978.4

(51) Int. Cl. H04W 72/56; H04L 5/00; H04L 12/18; H04W 16/28; H04W 64/00; H04W 72/044

(52) U.S. Cl. CPC H04W 72/56; H04L 5/0048; H04L 12/1845; H04W 16/28; H04W 64/003; H04W 72/044

(57) ABSTRACT

A terminal and a method thereof are provided for identifying positions of base stations in a wireless communication system. The method includes determining, from among a plurality of beam indices, first beam indices, based on directions of multiple cells; identifying whether to prioritize the first beam indices in a time domain, a frequency domain, or a code domain; and transmitting, to the multiple cells, sounding reference signals (SRSs), wherein in case that the first beam indices are prioritized in the time domain, the SRSs indicate the first beam indices using a starting slot of a subframe.

### CROSS-REFERENCE TO RELATED APPLICATION(S)

The application is a continuation of U.S. application Ser. No. 17/525,087, which was filed in the U.S. Patent and Trademark Office on Nov. 12, 2021, and is based on and claims priority under 35 U.S.C. § 119(a) to Great Britain (GB) Patent Application No. 2017978.4, which was filed in the United Kingdom (UK) Intellectual Property Office (IPO) on Nov. 16, 2020, the entire disclosure of each of which is incorporated herein by reference.

### BACKGROUND

### 1. Field

The disclosure relates generally to improvements in positioning of a User Equipment (UE), and more particularly, to improved positioning of a UE in an Industrial Internet of things (IIoT) environment.

### 2. Description of Related Art

To meet the increasing demand for wireless data traffic since deployment of 4th generation (4G) communication systems, efforts have been made to develop an improved 5th generation (5G) or pre-5G communication system. The 5G or pre-5G communication system, which may also be referred to as a ‘beyond 4G network’ or a ‘post long term evolution (LTE) system’, is intended to be implemented in higher frequency (mmWave) bands, e.g., 60 GHz bands, in order to utilize higher data rates. To decrease propagation loss of the radio waves and increase the transmission distance, beamforming, massive multiple-input multiple-output (MIMO), full dimensional MIMO (FD-MIMO), array antenna, analog beamforming, and large scale antenna techniques are being discussed with respect to 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation, etc. In a 5G system, hybrid frequency shift keying (FSK) and Feher's quadrature amplitude modulation (FQAM) and sliding window superposition coding (SWSC) have been developed for advanced coding modulation (ACM), and filter bank multi carrier (FBMC), non-orthogonal multiple access (NOMA), and sparse code multiple access (SCMA) have been developed as advanced access technologies.

The Internet is now evolving to the Internet of things (IoT) where distributed entities, i.e., things, exchange and process information without human intervention. The Internet of everything (IoE), which is a combination of the IoT technology and the big data processing technology through connection with a cloud server, has also emerged.

As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), etc., have been researched. Such an IoT environment may provide intelligent Internet technology services that collect and analyze data generated among connected things. IoT may be applied to a variety of fields including smart homes, smart buildings, smart cities, smart cars or connected cars, smart grid, health care, smart appliances, and advanced medical services through convergence and combination between existing information technology (IT) and various industrial applications.

In line with this, various attempts have been made to apply 5G communication systems to IoT networks. For example, technologies such as a sensor network, MTC, and M2M communication may be implemented by beamforming, MIMO, and array antennas. Application of a cloud RAN as the above-described big data processing technology may also be considered to be as an example of convergence between the 5G technology and the IoT technology.

As described above, various services can be provided according to the development of a wireless communication system, and thus a method for easily providing such services is required.

In an IIoT environment, such as an automated factory, it is desirable to be able to determine the position of a UE to a high degree of accuracy and with as little delay as possible. However, even using state of the art 5G technologies, there can be an undesirable lack of accuracy and delay in acquiring the results. Even ultra reliable low latency communication (URLLC), as known in 5G, may not provide the required performance.

### SUMMARY

This disclosure is provided to address at least the problems and/or disadvantages described above and to provide at least the advantages described below.

In accordance with an aspect of the disclosure, a method performed by a terminal is provided. The method includes determining, from among a plurality of beam indices, first beam indices, based on directions of multiple cells; identifying whether to prioritize the first beam indices in a time domain, a frequency domain, or a code domain; and transmitting, to the multiple cells, sounding reference signals (SRSs). In case that the first beam indices are prioritized in the time domain, the SRSs indicate the first beam indices using a starting slot of a subframe.

In accordance with another aspect of the disclosure, a terminal is provided for use in a wireless communication system. The terminal includes a transceiver; and at least one processor coupled with the transceiver and configured to determine, from among a plurality of beam indices, first beam indices, based on directions of multiple cells, identify whether to prioritize the first beam indices in a time domain, a frequency domain, or a code domain, and transmit, to the multiple cells, SRSs. In case that the first beam indices are prioritized in the time domain, the SRSs indicate the first beam indices using a starting slot of a subframe.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates an IIoT environment according to an embodiment;

FIG. 2 is a flowchart illustrates a method according to an embodiment;

FIG. 3 is a graph illustrating a positioning time delay according to an embodiment in comparison with the prior art;

FIG. 4 is a graph illustrating a positioning error according to an embodiment;

FIG. 5 illustrates a UE according to an embodiment;

FIG. 6 illustrates a base station according to an embodiment; and

FIG. 7 is a flow chart illustrating a method performed by a terminal according to an embodiment.

### DETAILED DESCRIPTION

Various embodiments of the disclosure will now be described in detail with reference to the accompanying drawings. In the following description, specific details such as detailed configuration and components are merely provided to assist the overall understanding of these embodiments. Therefore, it should be apparent to those skilled in the art that various changes and modifications of the embodiments described herein can be made without departing from the scope and spirit of the disclosure. In addition, descriptions of well-known functions and constructions are omitted for clarity and conciseness.

Those skilled in the art will understand that the principles of the disclosure may be implemented in any suitably arranged system or device. Additionally, other technical features may be readily apparent to one skilled in the art from the following figures, descriptions, and claims.

Before undertaking the descriptions below, definitions of certain words and phrases used throughout this patent document are provided as follows.

The term “couple” and its derivatives refer to any direct or indirect communication between two or more elements, whether or not those elements are in physical contact with one another.

The terms “transmit,” “receive,” and “communicate,” as well as derivatives thereof, encompass both direct and indirect communication.

The terms “include” and “comprise,” as well as derivatives thereof mean inclusion without limitation.

The term “or” is inclusive, meaning and/or.

The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

The term “controller” includes any device, system or part thereof that controls at least one operation. Such a controller may be implemented in hardware or a combination of hardware and software and/or firmware. The functionality associated with any particular controller may be centralized or distributed, whether locally or remotely.

The phrase “at least one of,” when used with a list of items, indicates that different combinations of one or more of the listed items may be used, and only one item in the list may be needed. For example, “at least one of: A, B, and C” includes any of the following combinations: A, B, C, A and B, A and C, B and C, and A and B and C.

Various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

In accordance with an aspect of the disclosure, an apparatus and method are provided. Other features of the disclosure will be apparent from the dependent claims, and the description which follows.

According to an embodiment, a method is provided for determining a position of a UE in a telecommunication network. The method includes the UE prioritizing beam indices in one or more of time, frequency, or code domains in uplink (UL) transmissions to one or more base stations (gNBs) in the telecommunication network; and localization functions determining the UE position based on information provided by the one or more gNBs.

Beams set to a low priority are muted, assigned a low periodicity, or assigned a low detectable code.

The telecommunication network is operable in a CoMP or non-CoMP configuration.

If the telecommunication network is in the non-CoMP configuration, the UE is provided with location details of the gNBs in the telecommunication network.

If the beam indices are prioritized in a time domain, then beam indices having a higher priority are located earlier in a subframe.

If the beam indices are prioritized in a frequency domain, then beam indices having a higher priority are first used to fill frequency slots.

If the beam indices are prioritized in a code domain, then spreading codes with zero or low cross correlation and higher detectable properties are used.

If the UE changes position, the beam indices are updated.

The prioritizing includes determining a location associated with either a serving or neighbor gNB and steering a beam towards the location or, in a fixed beam system, identifying a beam having the best signal strength in a direction of the serving or neighbor gNB.

According to an embodiment, a UE is provided for use in a telecommunication network. The UE is configured to prioritize beam indices in one or more of time, frequency, or code domains in UL transmissions to one or more gNBs in the telecommunication network.

The prioritizing includes determining a location associated with either a serving or neighbor gNB and steering a beam towards the location or, in a fixed beam system, identifying a beam having the best signal strength in a direction of the serving or neighbor gNB.

According to an embodiment, a telecommunication system is provided, which includes a UE as described above, and at least one gNB of a telecommunication network.

For some IIoT applications, both high precision and high speed positioning will be important. For UL applications in which a central localization server estimates the positions of UEs, a combination of time of arrival (ToA) and angle of arrival (AoA) methods can be used to obtain high precision. With a higher number of beams, both at a gNB and a UE, precision levels can be improved. When scanning though the beams in the time domain to select the best beam (and hence the AoA), a delay in positioning may be experienced due to the use of time slots and the fact that a desired beam may not exist in a given first timeslot.

Embodiments of the disclosure provide for the prioritization of beams that are most relevant to the positioning procedures when the beam scanning is performed in the time domain.

Further embodiments of the disclosure provide for the facilitation of UL beam scanning in code and/or frequency domains. In this way, the time-dependent nature of beam scanning is largely removed, and the delay can be minimized. Again, prioritization of the beams that are most relevant to the positioning procedures is proposed, as the ability to beam scan in the code and/or frequency domains can be constrained by many factors.

The constraints in the frequency/code domains are addressed by allowing the UE/device to operate in a given bandwidth part (BWP). The prioritization in time, frequency, or code domains can also reduce the high variance in the time used to estimate the AoA, thus, providing a high degree of stability for the speed of localization.

An example of a device to be controlled in an IIoT setting is a robotic arm, which may move at high speed and which should be located with a high degree of accuracy. Herein, devices such as the robotic arm are referred to as a UE, a terminal, or a device. It is important to note that UE in this disclosure does not necessarily refer to a typical mobile telephone as used for personal communications. Instead, a UE is to be interpreted as a device operating with a telecommunication network, which may be a private network, such as an IIoT network. These UEs (devices) may not be subjected to the typical constraints of size, complexity power consumption, or cost as a typical mobile UE.

Embodiments of the disclosure provide highly precise, low latency positioning in the UL for IIoT networks and facilitates the use of AoA techniques with fine angle resolution. To provide the low latency, the beam indexes of prioritized directions are indicated more frequently in the frequency or code domains, so simultaneous identification of these directions can be performed by multiple gNBs. Two mechanisms for prioritizing such directions for two types of deployment include new radio CoMP (NR-CoMP) and non-CoMP (e.g., a single serving gNB).

Embodiments of the disclosure effectively exploit wider bandwidths available for mm-wave systems to provide faster and highly accurate positioning, while addressing the limitations of a number of concurrent beams a UE/device can support and possible limits enforced by the BWPs.

Embodiments of the disclosure are applicable in IIoT settings, where fast and highly precise localization is performed by a central controller.

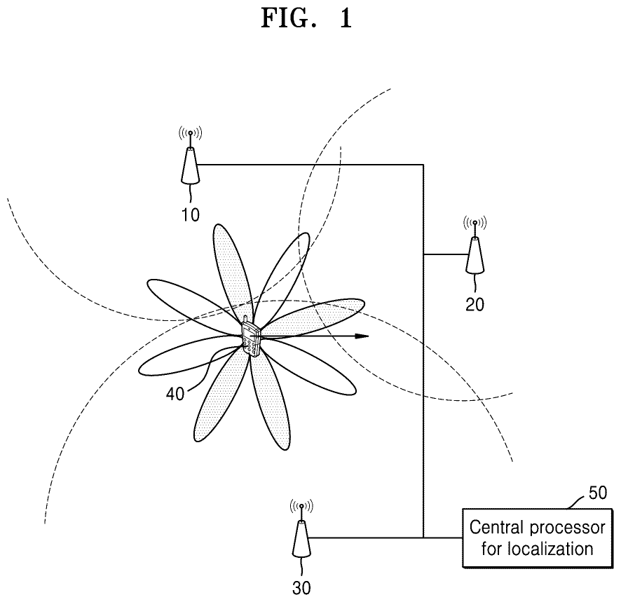

FIG. 1 illustrates an IIoT environment according to an embodiment.

Referring to FIG. 1, three gNBs 10, 20, and 30 are arranged around a site and each is communicating with a UE 40 in an NR-CoMP configuration. A central localization processor 50 is also provided to communicate with each of the gNBs 10, 20, and 30.

It is faster to localize UEs/devices with UL signals, rather than have a UF/device measure downlink reference signals and then report them via the UL. Therefore, UL positioning may be utilized. The combination of observed time difference of arrival (OTDoA) and AoA methods can yield very high precision in positioning. For UL AoA methods, the gNBs should detect the best beam for the UE signals and then report information associated with the detected beam to a central processor. The SRS in the UL can be used to indicate the beam indexes, thereby, effectively supporting beam sweeping.

For many high-end applications in the IIoT domain, such as the robotic arm mentioned previously, the cost, complexity, and/or the power consumption of the devices are not primary concerns, since they are highly specialized devices configured for a particular purpose, unlike a regular mobile telephone. However, the BWP concept applies to many operating environments and may limit the operating bandwidth of a UE/device to a part of a total bandwidth. Therefore, UL beam sweeping may be utilized in the code and frequency domains, which is effective under this BWP constraint as well.

Often, IIoT networks are set-up in factories or offices and will have a large number of small cells (gNBs) configured as a secure network. As such, the networks will not be coverage limited and there may be more than one cell with a good signal with which the UE/device can communicate, which can act as a serving cell. The CoMP concept can be easily applied in this scenario, where multiple gNBs can jointly serve the UE/device, thus turning what would otherwise be interference into wanted signals, thereby improving link quality.

Even without CoMP, and with a single gNB serving a UE/device, the geometry of the factory/hall and the fixed positions of the gNBs can be stored in the UE/devices, so that the device can estimate the direction and position of the serving gNB and effectively localize the nearest neighbor gNB directions, using the pre-stored information regarding the layout of gNBs.

The use of combined OTDoA and AoA methods can also achieve very high precision in positioning. In line of sight (LOS) scenarios, having AoA information with a single (serving) gNB can be sufficient to yield high accuracy. However, when there are non-LOS (NLOS) conditions involved, having AOA information with multiple gNBs can help to remove the incorrect positioning estimates and improve the overall accuracy. Here, the focus is on this AoA estimation with multiple gNBs, combined with OTDOA to derive very high accuracies.

To effectively shorten the time taken for UL beam sweeping, the SRS based beam indexes are placed selectively in the time, frequency, or code domains. Due to factors such as implementation of the BWP in the UL and hardware limitations on how many concurrent beams can be configured in the device, not all the beams can be indicated at the same time in frequency or code domains. For the time domain scanning, placing the most relevant beams first for positioning can reduce the time taken for positioning operations significantly. Thus, the time, frequency, and code domains may be utilized for beam indexing and the beam indications may be prioritized as per the following criteria.

With CoMP, multiple gNBs can be connected to a UE/device at the same time, providing data connectivity, e.g., as illustrated in FIG. 1.

The UE/device 40 has knowledge about the directions of the serving gNBs 10, 20, and 30 in this scenario, and therefore, the UE/device 40 can prioritize the beam indices for these directions, corresponding to the serving gNBs 10, 20, and 30. The prioritized beams are indicated as shaded in FIG. 1.

With regards to the time domain solution, the beam indices having the highest priority (i.e., those aligned with the serving gNBs in the CoMP scenario or those aligned with the serving gNB and near neighbors in the non-CoMP scenario) can be located in earlier time slots in the subframe.

Conventionally, without prioritization, beams are distributed in slots throughout the subframe. However, in accordance with an embodiment of the disclosure, by prioritizing beams and placing those with highest priority at the start of the subframe, delay can be minimized and accuracy can be increased.

If the beam sweeping is in the frequency domain, the beam indices for serving gNB directions can be first used to fill the frequency slots. If there are other slots available, the indices of the adjacent beams can be used to fill these slots. Such a beam roster is transmitted with a high regularity (with high periodicity). The other beam indices (i.e., that make up the full beam set) can be transmitted intermittently (with low periodicity).

Referring again to FIG. 1, when the UE/device 40 moves further (as shown by the arrow) and a new CoMP set of serving gNBs is formed, and the beam directions will be updated. These new beam indices are then used as a new priority list.

If the code domain is employed to differentiate beam indices, spreading codes with zero (or low) cross correlation properties can be used. Zadoff-Chu codes are one such example.

Using the full available bandwidth (or BWP) by spreading the information in the code domain is beneficial in certain situations. For example, if there is high relative speed between the device/UE and the gNB, the Doppler effects may distort the information in the frequency domain. The code domain is, therefore, more effective in this scenario. The same principle, as before, of high periodicity for beam indices with the serving gNB directions and low periodicity for other beam indices can be used. Alternatively, some code trees offer the possibility to vary the detectability by differentiating through the spreading factor and/or repetition factor. The beam indices of the serving gNB directions can be coded with high detectability and the others with low detectability. There are only a few codes with high detectability and vice-versa, so the high detectable codes are used for the serving gNB beam directions and adjacent ones.

Alternatively, muting of SRS beam indices for the low priority beams can be used to include more beams in this space and also to increase the hearability of the high priority beams in a cyclic manner. By reducing the beam scanning to indicate only the high priority beams in all of the domains (time, frequency and code), the signaling overheads can also be reduced.

As indicated above, FIG. 1 illustrates the preferred beam directions with shading. These beams can be prioritized in the time, frequency, and/or code domain. In practice, the serving gNBs are also likely to have multiple beams in this high frequency (mm-wave) deployment, but these are not shown for clarity. The use of such beams at the gNB side further enhances accuracy of positioning.

If the IIoT network employs a non-CoMP (single serving gNB) configuration, then the direction of only the serving gNB can be obtained in real-time, through downlink (DL) communications.

Such a situation differs from that illustrated in FIG. 1 in that the UE 40 is only actively connected to one of the gNBs 10, 20, and 30, rather than actively communicating with all three of them.

In this situation, an estimate of the neighbor gNB directions can be derived through the use of pre-stored information (on the UE/device 40) of the floor plans and the gNB 10, 20, and 30 positions of the IIoT network. This information, which is not likely to be changed frequently, can be easily pre-stored in the UE 40 so that such information is available at all times to the UE 40, which can be provided with a suitable level of computational/storage.

Once the UE/device 40 estimates the best set of neighbor gNBs, beam directions can be prioritized for the serving gNB and the set of neighbor gNBs, based on real-time data for the serving gNB and estimates of the neighboring gNBs, as set out above. The options for indicating these beam indices in the frequency and code domains are the same as set out above in connection with the CoMP configuration.

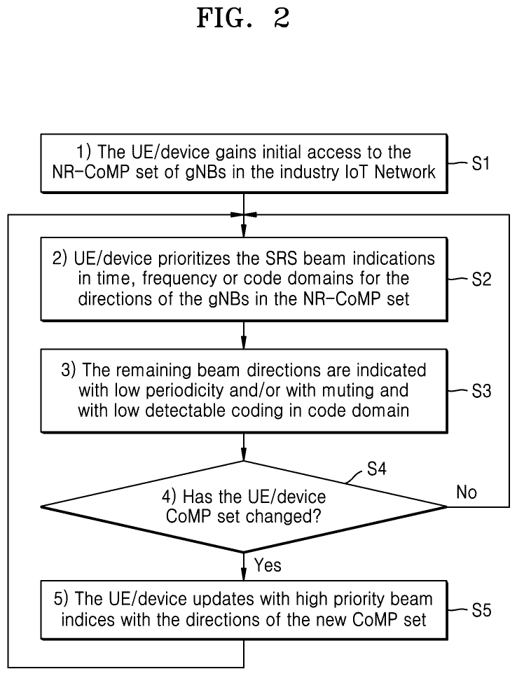

FIG. 2 is a flowchart illustrating a method according to an embodiment. Although the method of FIG. 2 is described in relation to the NR-CoMP configuration with reference to the IIoT environment illustrated in FIG. 1, with minor changes, as will be described later, it may also be directed to the non-CoMP configuration.

Referring to FIG. 2, in step S1, the UE 40 gains initial access to the network, e.g., by using known registration and access techniques.

In step S2, the UE 40 sets SRS beam priorities in simultaneous slots in the frequency and/or code domains, or in the time domain, to coincide with directions of gNBs 10, 20, and 30 in the NR-CoMP set. These are the shaded beams in FIG. 1.

In step S3, the non-prioritized beams may be muted or set to low periodicity and with low detectable coding in the code domain.

In step S4, a check is made to determine if the CoMP set (i.e., the relevant gNBs) has changed. If not, the method returns to step S2. However, if the set has changed, the UE 40 updates the high priority indices with the directions to the gNBs in the new CoMP set in step S5. From here, the method returns to step S2 and continues as above.

As mentioned, in the case of non-CoMP operation, the steps in the flowchart differ a little, but the basic mode of operation is very similar. In the non-CoMP case, at step S1 the UE 40 estimates the direction to each of the N nearest gNBs by making use of the pre-stored information relating to gNB locations available at or to the UE 40. Further, at step S5 the UE 40 updates the high priority beam indices with the newly estimated directions to the nearest N gNBs to its current position.

As can be seen, the method as set out in the flowchart of FIG. 2 ensures that the UE 40 is able to properly direct beams to either the gNBs in the CoMP set with which it is operating or to direct beams to a defined number of neighbors by making use of pre-stored information regarding the layout of gNBs in the network. The steps referred to above reflect these differences.

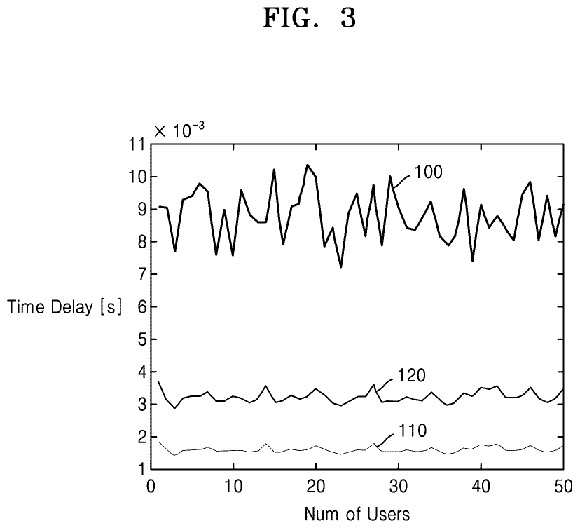

FIG. 3 is a graph illustrating a positioning time delay according to an embodiment in comparison with the prior art. In particular, the graph in FIG. 3 compares beam location delay for time frequency domain beam scanning for 50 UE locations (x axis).

Referring to FIG. 3, a time domain beam scan 100 is limited by the longest delay among the 3 gNBs and shows a high degree of variability. In a frequency domain 110, according to an embodiment of the disclosure, all the beams are scanned in the same time slot and the variability in deciding the AoA is much lower. This delay here is close to 1 ms, which is typically over five times faster than the average delay for the conventional time domain, non-prioritized beam scanning. Results in the code domain are similar to those in the frequency domain 110. Also shown are the results 120 of prioritization of beam indices in the time domain. This demonstrates an improvement over the non-prioritized scan 100.

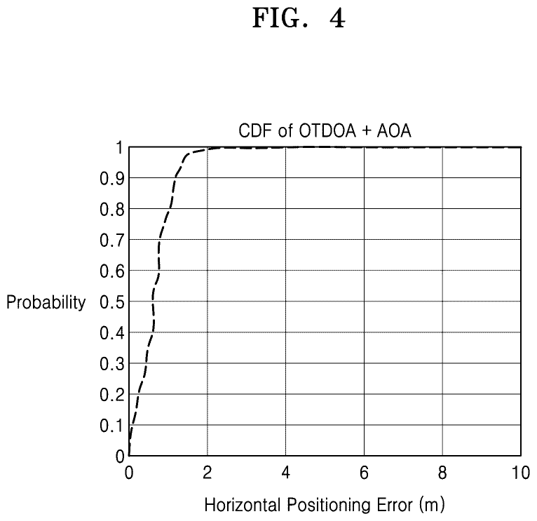

FIG. 4 is a graph illustrating a positioning error according to an embodiment. Specifically, the graph in FIG. 4 shows a corresponding localization error in a cumulative distribution function (CDF) when actually executing the AoA+OTDOA combined method according to an embodiment of the disclosure.

Referring to FIG. 4, the accuracy error level is below 2 m error for 99% of the time. Additional steps of increasing the number of beams in the UE, increasing the number of gNBs, or including beamforming in the gNB can increase the accuracy down to centimeter levels, while the same basic trends of delay reductions, as shown in FIG. 3, remain.

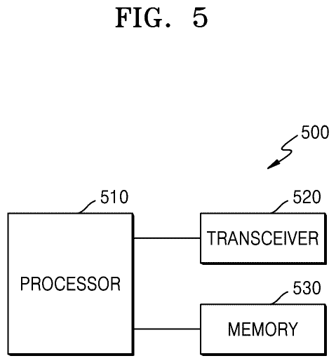

FIG. 5 illustrates a UE according to an embodiment.

Referring to the FIG. 5, a UE 500 includes a processor 510, a transceiver 520, and a memory 530. However, all of the illustrated components are not essential. The UE 500 may be implemented by more or less components than those illustrated in the FIG. 5. Alternatively, the processor 510, the transceiver 520, and the memory 530 may be implemented as a single chip.

The processor 510 may include one or more processors or other processing devices that control the proposed function, process, and/or method. Operation of the UE 500 may be implemented by the processor 510.

The transceiver 520 may be connected to the processor 510 and transmit and/or receive a signal. In addition, the transceiver 520 may receive the signal through a wireless channel and output the signal to the processor 510. The transceiver 520 may transmit the signal output from the processor 510 through the wireless channel.

The memory 530 may store the control information or the data included in a signal obtained by the UE 500. The memory 530 may be connected to the processor 510 and store at least one instruction or a protocol or a parameter for the proposed function, process, and/or method. The memory 530 may include ROM, RAM, a hard disk, a CD-ROM, a DVD, and/or other storage devices.

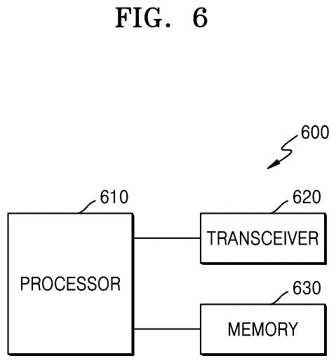

FIG. 6 illustrates a base station according to an embodiment.

Referring to the FIG. 6, the base station 600 includes a processor 610, a transceiver 620, and a memory 630. However, all of the illustrated components are not essential. The base station 600 may be implemented by more or less components than those illustrated in FIG. 6. Alternatively, the processor 610, the transceiver 620, and the memory 630 may be implemented as a single chip.

The processor 610 may include one or more processors or other processing devices that control the proposed function, process, and/or method. Operation of the base station 600 may be implemented by the processor 610.

The transceiver 620 may be connected to the processor 610 and transmit and/or receive a signal. The signal may include control information and data. In addition, the transceiver 620 may receive the signal through a wireless channel and output the signal to the processor 610. The transceiver 620 may transmit a signal output from the processor 610 through the wireless channel.

The memory 630 may store the control information or the data included in a signal obtained by the base station 600. The memory 630 may be connected to the processor 610 and store at least one instruction or a protocol or a parameter for the proposed function, process, and/or method. The memory 1430 may include ROM, RAM, hard disk, CD-ROM, DVD, and/or other storage devices.

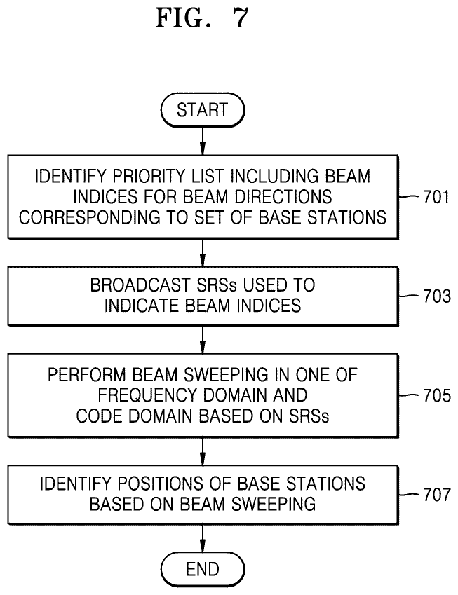

FIG. 7 is a flow chart illustrating a method performed by a terminal according to an embodiment.

Referring to FIG. 7, in step 701, the terminal identifies a priority list including indices for beam directions corresponding to a set of base stations. In case that CoMP is employed in an IIoT network, the set of base stations may include CoMP base stations connected to the terminal at the same time. In case that non-CoMP is employed in an IIoT network, the set of base stations may include a single base station connected to the terminal and a set of neighboring base stations. When the non-CoMP is employed, the terminal may identify beam directions for the neighboring base stations based on position data and pre-stored map data.

In step 703, the terminal broadcasts SRSs used to indicate the beam indices.

In step 705, the terminal performs beam sweeping in one of a frequency domain and a code domain, based on the SRSs.

In case that the beam sweeping is performed in the frequency domain, the beam indices are used to fill frequency slots. For example, if second frequency slots are available, other beam indices corresponding to other beam directions adjacent to the beam directions, are used to fill the second frequency slots. Information associated with the first frequency slots is transmitted with higher periodicity than information associated with the second frequency slots.

When the beam sweeping is performed in the code domain, spreading codes with zero cross correlation properties may be used.

In step 707, the terminal identifies positions of the base stations based on the beam sweeping. The terminal may update the priority list if the set of base stations is changed. For example, when CoMP is employed, the terminal may update the priority list if the set of base stations including the CoMP base stations is changed. The set of base stations including the CoMP base stations may be changed due to a movement of the terminal or a change of positions of the base stations.

When non-CoMP is employed, the terminal may update the priority list if the terminal is moved or positions of the base stations are changed.

In accordance with an embodiment, a method of determining the position of a UE in a telecommunication network is provided. The method includes the UE prioritizing beam indices in one or more of time, frequency, or code domains in UL transmissions to one or more gNBs in the telecommunication network; and localization functions are performed for determining the UE position based on information provided by the gNBs.

Beams set to a low priority are muted, assigned a low periodicity, or assigned a low detectable code.

The telecommunication network is operable in CoMP or non-CoMP configurations.

If the telecommunication network is in the non-CoMP configuration, the UE is provided with location details of the gNBs in the telecommunication network.

If the beam indices are prioritized in a time domain, then beam indices having a higher priority are located earlier in a subframe.

If the beam indices are prioritized in a frequency domain, then beam indices having a higher priority are first used to fill frequency slots.

If the beam indices are prioritized in a code domain, then spreading codes with zero or low cross correlation and higher detectable properties are used.

If the UE changes position, the beam indices are updated.

The prioritizing includes determining a location associated with either a serving or neighbor gNB and steering a beam towards the location or, in a fixed beam system, identifying a beam having the best signal strength in a direction of the serving or neighbor gNB.

In accordance with an embodiment, a UE is provided for use in a telecommunication network. The UE is configured to prioritize beam indices in one or more of time, frequency, or code domains in UL transmissions to one or more gNBs in the telecommunication network.

The prioritizing includes determining a location associated with either a serving or neighbor gNB and steering a beam towards the location or, in a fixed beam system, identifying a beam having the best signal strength in a direction of the serving or neighbor gNB.

In accordance with an embodiment, a telecommunication system is provided, which includes a UE and at least one gNB of a telecommunication network.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a field programmable gate array (FPGA) or an application specific integrated circuit (ASIC), which performs certain tasks or provides the associated functionality.

In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature described in this disclosure (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

While the disclosure has been shown and described with reference to certain embodiments thereof, it will be understood by those skilled in the art that various changes in form and details may be made therein without departing from the scope of the disclosure. Therefore, the scope of the disclosure should not be defined as being limited to the embodiments, but should be defined by the appended claims and equivalents thereof.

What is claimed is:

1. A method performed by a terminal in a wireless communication system, the method comprising:
determining, from among a plurality of beam indices, first beam indices, based on directions of multiple cells;
identifying whether to prioritize the first beam indices in a time domain, a frequency domain, or a code domain; and
transmitting, to the multiple cells, sounding reference signals (SRSs), wherein in case that the first beam indices are prioritized in the time domain, the SRSs indicate the first beam indices using a starting slot of a subframe.

2. The method of claim 1, wherein in case that the first beam indices are prioritized in the frequency domain, first frequency domain resources are used for the first beam indices and second frequency domain resources are used for second beam indices that are not prioritized.

3. The method of claim 2, wherein the first beam indices are indicated with a first periodicity and the second beam indices are indicated with a second periodicity.

4. The method of claim 3, wherein the first periodicity is higher than the second periodicity.

5. The method of claim 1, wherein in case that the first beam indices are prioritized in the code domain, the first beam indices are coded with a higher detectability than second beam indices that are not prioritized.

6. The method of claim 1, wherein the multiple cells include serving cells connected to the terminal.

7. A terminal in a wireless communication system, the terminal comprising:
a transceiver; and
at least one processor coupled with the transceiver and configured to:
determine, from among a plurality of beam indices, first beam indices, based on directions of multiple cells,
identify whether to prioritize the first beam indices in a time domain, a frequency domain, or a code domain, and
transmit, to the multiple cells, sounding reference signals (SRSs), wherein in case that the first beam indices are prioritized in the time domain, the SRSs indicate the first beam indices using a starting slot of a subframe.

8. The terminal of claim 7, wherein in case that the first beam indices are prioritized in the frequency domain, first frequency domain resources are used for the first beam indices and second frequency domain resources are used for second beam indices that are not prioritized.

9. The terminal of claim 8, wherein the first beam indices are indicated with a first periodicity and the second beam indices are indicated with a second periodicity.

10. The terminal of claim 9, wherein the first periodicity is higher than the second periodicity.

11. The terminal of claim 7, wherein in case that the first beam indices are prioritized in the code domain, the first beam indices are coded with a higher detectability than second beam indices that are not prioritized.

12. The terminal of claim 7, wherein the multiple cells include serving cells connected to the terminal.
